(19) United States
(12) Patent Application Publication
(10) Pub. No.: US 2022/0144044 A1
(43) Pub. Date: May 12, 2022

(54) COMPRESSOR REPLACEMENT KIT FOR VEHICLE AIR CONDITIONING SYSTEM

(71) Applicant: Kara Michelle Waldorf, Humboldt, IA (US)

(72) Inventor: Kara Michelle Waldorf, Humboldt, IA (US)

(21) Appl. No.: 17/094,277

(22) Filed: Nov. 10, 2020

(51) Int. Cl. B60H 1/32; B60H 3/06

(52) U.S. Cl. CPC B60H 1/3204; B60H 2003/0691; B60H 3/06

(57) ABSTRACT

A compressor replacement kit for a vehicle air conditioning system includes a package, a compressor disposed and engaged in the package, a drier filter disposed and engaged in the package, an expansion device disposed and engaged in the package, and a seal kit disposed and engaged in the package for allowing the user to find and purchase all the parts and elements and components needed or required for the vehicle air conditioning systems of the particular or selected vehicles easily and quickly.

### BACKGROUND OF THE INVENTION

### 1. Field of the Invention

The present invention relates to a compressor replacement kit for a vehicle air conditioning system, and more particularly to a compressor replacement kit for a vehicle air conditioning system including a complete kit for each vehicle air conditioning system of each vehicle for allowing the user to find and purchase all the parts and elements and components needed or required for a vehicle air conditioning system of a particular or selected vehicle.

### 2. Description of the Prior Art

Various kinds of typical vehicles, such as trucks, vans, pickups, cars, etc. have been developed and provided for carrying and moving purposes, and each vehicle include an air conditioning system provided therein for air conditioning purposes and providing a comfortable environment to the users, such that a lot of different air conditioning systems with various kinds of different parts and elements are developed and provided for each vehicle.

The parts and elements for different vehicles and different air conditioning systems can be purchased individually only, and it is time consuming and expensive to find and purchase the individual parts and elements when a plurality of different parts and elements used in making fluid circulation connections in a vehicle air conditioning system needs to be replaced.

For example, as shown in FIG. 1, the major parts and elements or components for a vehicle air conditioning system include at least a drier 90, a condenser 91, an evaporator 92, a compressor 93, an expansion valve 94, and O-rings 95, etc. However, each catalog for each vehicle shows only the single component by vehicle year, model make and size of the engine. If a vehicle owner goes to a vehicle dealer service or parts center for searching for the parts and elements or components for the vehicle air conditioning system of a particular vehicle, the dealer personnel often attempt to look up the air conditioning system in some type of computer or microfiche system having numerous other parts and systems stored therein, and it is time consuming and expensive to look up or find and retrieval and purchase the parts and elements or components.

The present invention has arisen to mitigate and/or obviate the afore-described disadvantages of the conventional parts and elements or components finding and retrieving problems.

### SUMMARY OF THE INVENTION

The primary objective of the present invention is to provide a compressor replacement kit for a vehicle air conditioning system including a complete kit for each vehicle air conditioning system of each vehicle for allowing the user to find and purchase all the parts and elements and components needed or required for a vehicle air conditioning system of a particular or selected vehicle.

In accordance with one aspect of the invention, there is provided a compressor replacement kit for a vehicle air conditioning system comprising a package, a compressor disposed and engaged in the package, a drier filter disposed and engaged in the package, an expansion device disposed and engaged in the package, and a seal kit disposed and engaged in the package.

The compressor replacement kit further comprises a second package, a second compressor disposed and engaged in said second package, a second drier filter disposed and engaged in said second package, a second expansion device disposed and engaged in said second package, and a second seal kit disposed and engaged in said second package.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view illustrating a vehicle air conditioning system for a vehicle;

FIG. 2 is a plan schematic view of a compressor replacement kit for a vehicle air conditioning system in accordance with the present invention; and

FIGS. 3, 4, 5 are plan schematic views similar to FIG. 2, illustrating the operation of the compressor replacement kit for the vehicle air conditioning system.

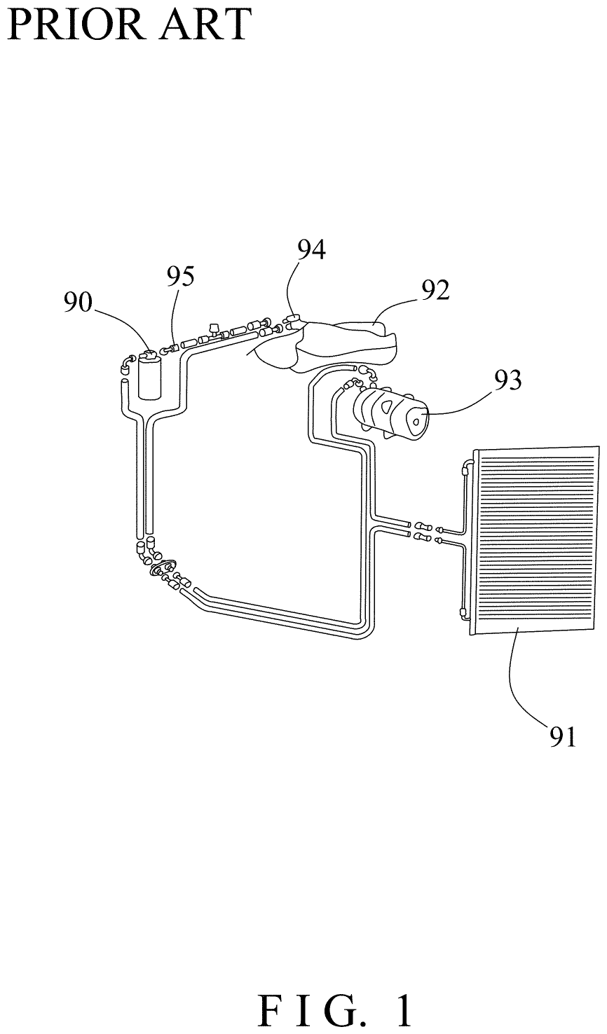

### DETAILED DESCRIPTION OF THE PREFERRED EMBODIMENT

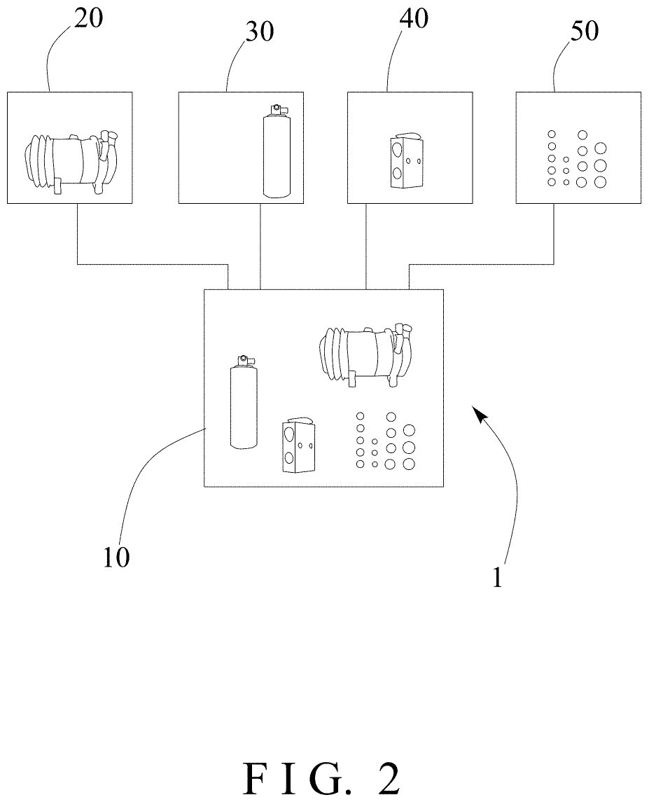

Referring to the drawings, and initially to FIG. 2, a compressor replacement kit 1 for a vehicle air conditioning system in accordance with the present invention comprises at least a compressor 20, such as a first compressor 20 of a component no #509-434 for a particular or selected vehicle compressor for such as a Sanden compressor #4664 or 4644, etc., a first drier filter 30, such as a first drier filter 30 of a component no #803-372 for the Sanden compressor #4664 or 4644, etc., a first expansion device 40, such as a first expansion device 40 of a component no #903-700 for the Sanden compressor #4664 or 4644, etc., and a first seal kit 50, such as a first seal kit 50 of a component no #600-5217 for the Sanden compressor #4664 or 4644, etc.

The complete kit 1 for the Sanden compressor #4664 or 4644, etc. for a vehicle air conditioning system of a particular or selected vehicle may thus be found and collected in an envelope or package 10, and the vehicle owner and/or the dealer personnel of the vehicle dealer service or parts center may easily and quickly look up and/or search and/or find and retrieve the needed or required parts and elements or components for the vehicle air conditioning system of a particular or selected vehicle.

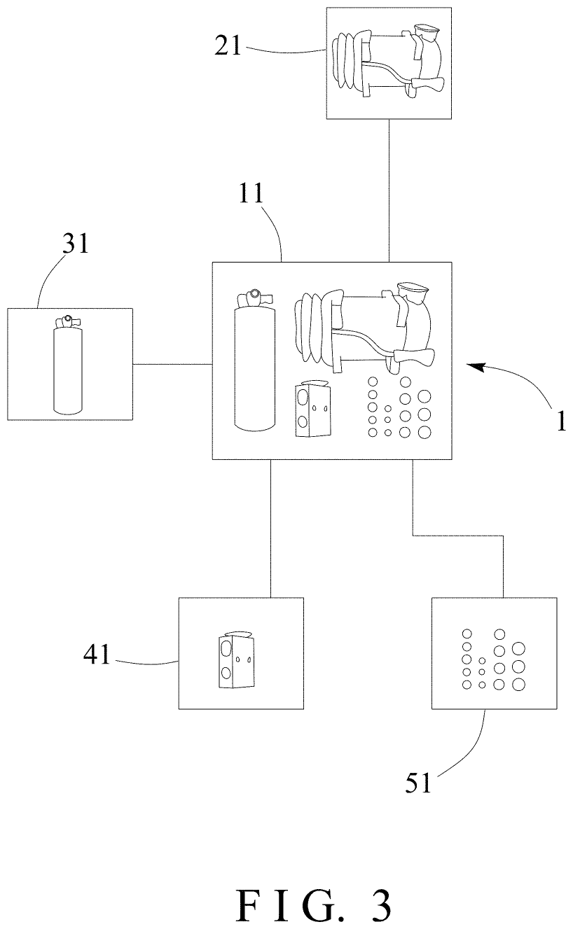

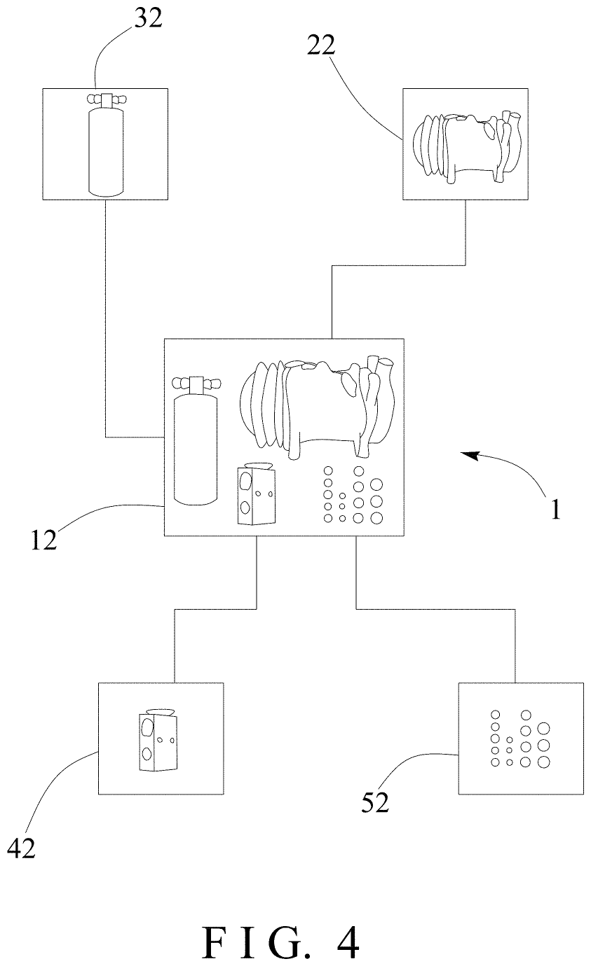

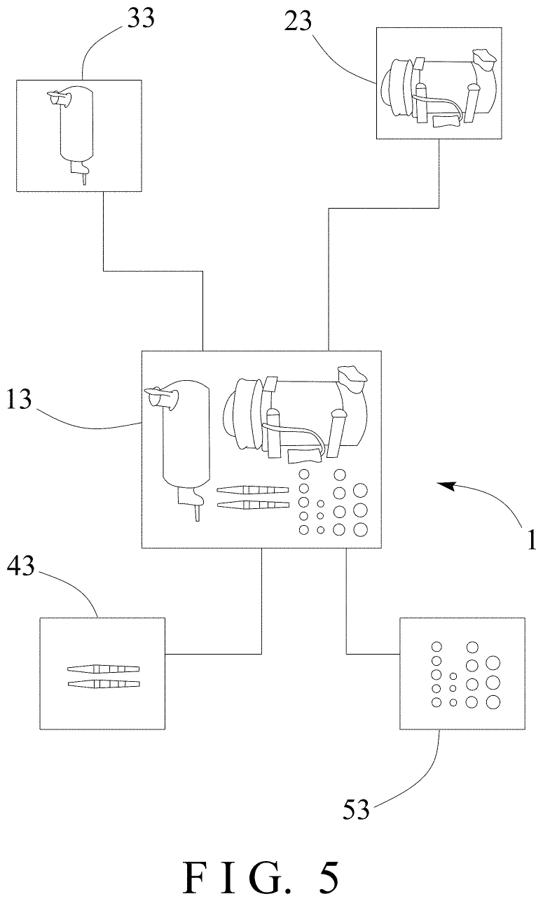

Similarly, as shown in FIGS. 3-5, one or more second compressors 21, 22, 23, and one or more second drier filters 31, 32, 33, and one or more second expansion devices 41, 42, 43, and one or more second seal kits 51, 52, 53, of the complete kits for different compressors of different vehicle air conditioning systems of different vehicles may also be found and collected in one or more second envelopes or packages 11, 12, 13, for allowing the user to find and purchase all the parts and elements and components needed or required for the vehicle air conditioning systems of the particular or selected vehicles easily and quickly.

Accordingly, the compressor replacement kit for a vehicle air conditioning system in accordance with the present invention includes a complete kit for each vehicle air conditioning system of each vehicle for allowing the user to find and purchase all the parts and elements and components needed or required for a vehicle air conditioning system of a particular or selected vehicle.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A compressor replacement kit for a vehicle air conditioning system comprising:
a package,
a compressor disposed and engaged in said package,
a drier filter disposed and engaged in said package,
an expansion device disposed and engaged in said package, and
a seal kit disposed and engaged in said package.

2. The compressor replacement kit as claimed in claim 1 further comprising:
a second package,
a second compressor disposed and engaged in said second package,
a second drier filter disposed and engaged in said second package,
a second expansion device disposed and engaged in said second package, and
a second seal kit disposed and engaged in said second package.
